(19) United States
(12) Patent Application Publication
(10) Pub. No.: US 2024/0372351 A1
(43) Pub. Date: Nov. 7, 2024

(54) Dual Messenger Rolling Spacer

(71) Applicant: Marmon Utility LLC, Milford, NH (US)

(72) Inventors: Robert Frederick NEUMANN, Merrimack, NH (US); Edward William LAUGHLIN, Lowell, MA (US); Mark A. BAKER, Bellefontaine, OH (US)

(73) Assignee: Marmon Utility LLC, Milford, NH (US)

(21) Appl. No.: 18/654,785

(22) Filed: May 3, 2024

Related U.S. Application Data
(60) Provisional application No. 63/499,849, filed on May 3, 2023.

(51) Int. Cl. H02G 7/12

(52) U.S. Cl. CPC H02G 7/12

(57) ABSTRACT

An apparatus for installing cables in overhead transmission and distribution systems and a corresponding method of use are disclosed herein. The apparatus described herein may comprise a dual messenger rolling cable spacer used to install cables in overhead transmission and distribution systems. In various embodiments, the method of using the dual messenger rolling cable spacer may include installing a carrier messenger wire across a span between utility structures. One or more rolling spacers may then be hung from the carrier messenger wire via a roller such that the roller is in contact with the carrier messenger wire. A set of cables and a circuit messenger wire may be affixed to the one or more rolling spacers. The circuit messenger wire may then be pulled across the span causing the one or more rolling spacers to roll along the carrier messenger wire, thereby pulling the set of cables across the span.

### RELATED APPLICATIONS

This application claims priority to U.S. Provisional Patent Application No. 63/499,849, filed May 3, 2023, the content of which is hereby incorporated herein by reference in its entirety.

### FIELD OF THE DISCLOSURE

The present invention relates to power distribution systems and, more particularly, to an apparatus used to install cables in overhead transmission and distribution systems.

### BACKGROUND OF THE INVENTION

Overhead conductor cables are commonly suspended from a messenger wire typically made of high strength alloys that is rigidly fixed to and supported by a set of poles or towers. This messenger wire, also referred to as a messenger cable, is used in part to install cables, such as conductor or transmission and distribution cables commonly used for communication or electrical transmission and distribution. Installation of the cables is a tedious and expensive process, since it conventionally requires the use of devices that must be replaced with permanent fixtures that retain the cables for indefinite periods of time. The use of these many installation and permanent retention components comes at a high cost to utility companies. These costs, coupled with the expense in man hours for installation of the cables adds significant costs to the operational budgets of the utility companies, which is passed along to the consumer in the form of higher utility bills.

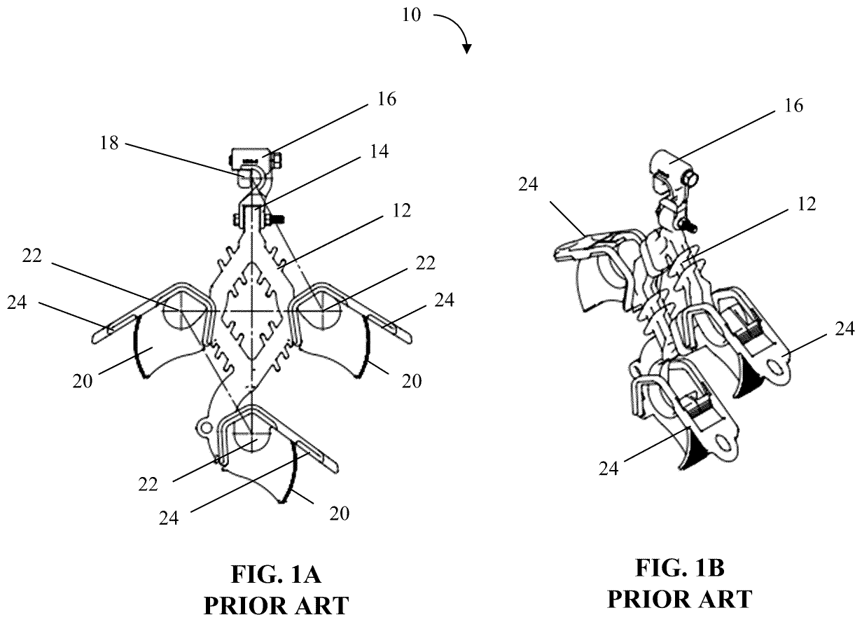

One of the devices conventionally used to retain cables in aerial positions is a cable spacer. Cable spacers are typically configured to clamp to a messenger wire and support up to three electrical circuit cables. A messenger wire, also referred to as a messenger cable, is an aluminum steel composite wire, with higher tensile strength than an electrical circuit cable. FIGS. 1A-B depict a front view and a perspective view of a cable spacer 10, respectively, in accordance with the prior art. The cable spacer 10 includes a body member 12, a hanging arm 14, and a messenger wire engagement area 16 for receiving a messenger wire 18. The body member 12 has a plurality of cable seats 20 for holding a plurality of cables 22. Retaining means 24 are pivotal on the cable spacer 10 to secure the cables 22 within the cable seats 20. The retaining means 24 may use a ratchet system for securing the cable 22 within the cable seats 20. In use, the cable spacer 10 is hung on the messenger wire 18 and cables 22 are placed in the cable seats 20 to suspend them in a position below the messenger wire 18. Due to the elongated nature and the resulting weight of the cables 22, the spacers 10 must be positioned at predetermined intervals along the cable path.

Conventionally, when installing cables on messenger wires, sheave pulley blocks are suspended from a messenger wire and used by a utility worker to pull the cables across a span from one pole (referred to herein as a “departure pole”) to another pole (referred to herein as an “arrival pole”). Each sheave pulley block would then need to be removed and replaced with a cable spacer. To do this, a utility worker would need to attach the spacer to the messenger wire and insert the electrical cables into the spacer, often at various heights and positions throughout the span. Typically, this is accomplished using a bucket truck, which is a vehicle with a worker platform, or “bucket,” that extendable from the ground to a height and distance needed to access the overhead messenger wire. However, when there is no access below the messenger wire for a bucket truck (e.g., when the span between the departure pole and arrival pole traverses a river, a valley, heavy vegetation, or other terrain prohibiting the use of a bucket truck), a bosun chair or trolley may be used. A bosun chair or trolley is a device used to attach an electrical worker to an overhead messenger wire, while allowing the worker to move along the messenger wire throughout the span. In addition to being particularly time intensive, the use of a bosun chair or trolley also places a utility worker at a greater risk of serious injury or death.

As such, there is a need for an improved system and method for installing cables on messenger wires across inaccessible spans that reduces costs related to having to replace the devices used to install the cables and minimizes the risk to the safety of utility workers.

### SUMMARY OF THE INVENTION

Aspects of this disclosure relate to systems and method for installing cables in overhead transmission and distribution systems. According to one aspect of the invention, an apparatus described herein may comprise a dual messenger rolling cable spacer used to install cables in overhead transmission and distribution systems. According to another aspect of the invention, the systems and methods described herein include a method of using dual messenger rolling cable spacers to install cables in an overhead transmission and distribution system. In various embodiments, the method may include installing a carrier messenger wire across a span between utility structures. The utility structures may comprise poles or other structures used to suspend wires and cables in overhead transmission and distribution systems. The carrier messenger wire may be rigidly affixed to a utility structure on each end of the span. In various embodiments, the method may include preassembling a set of one or more cables, one or more rolling spacers used to retain the set of cables, and a circuit messenger wire. The circuit messenger wire may comprise a second separate messenger wire that is provided in addition to the carrier messenger wire. In some embodiments, preassembling the set of cables, the one or more rolling spacers, and the circuit messenger wire may comprise clamping each of the set of cables and the circuit messenger wire to the one or more rolling spacers. In various embodiments, the method may include hanging the one or more rolling spacers from the carrier messenger wire, wherein the set of cables and the circuit messenger wire are affixed to the one or more rolling spacers. Each of the one or more rolling spacers may be hung from the carrier messenger wire via a roller of the one or more rolling spacers such that the roller is in contact with the carrier messenger wire. The one or more rolling spacers may be configured to roll along the carrier messenger wire when hung from the carrier messenger wire. In various embodiments, the method may further include pulling the circuit messenger wire across the span causing the one or more rolling spacers to roll along the carrier messenger wire, thereby pulling the set of cables across the span. Once pulled across the span, the set of cables and the one or more rolling spacers may be secured in place by affixing the circuit messenger wire to a utility structure defining an end of the span.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRA WINGS

The present invention is illustrated by way of example and not limited in the accompanying figures in which like reference numerals indicate similar elements and in which:

FIGS. 1A-B depict a front view and a perspective view of a cable spacer, respectively, in accordance with the prior art;

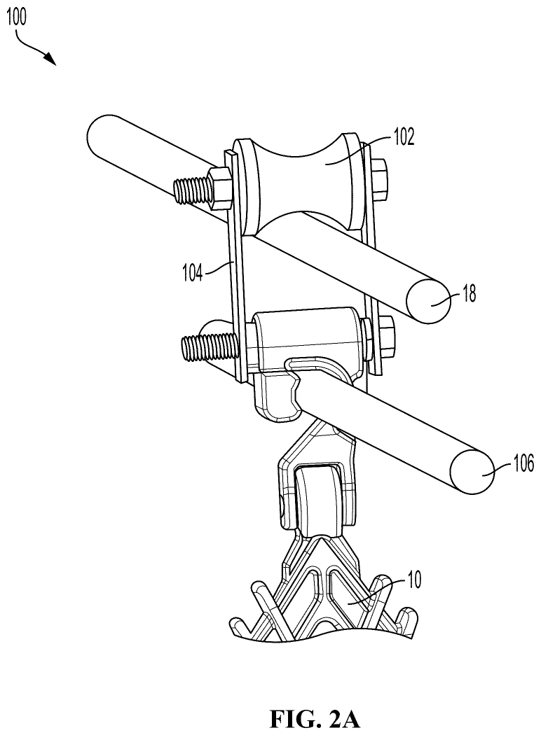

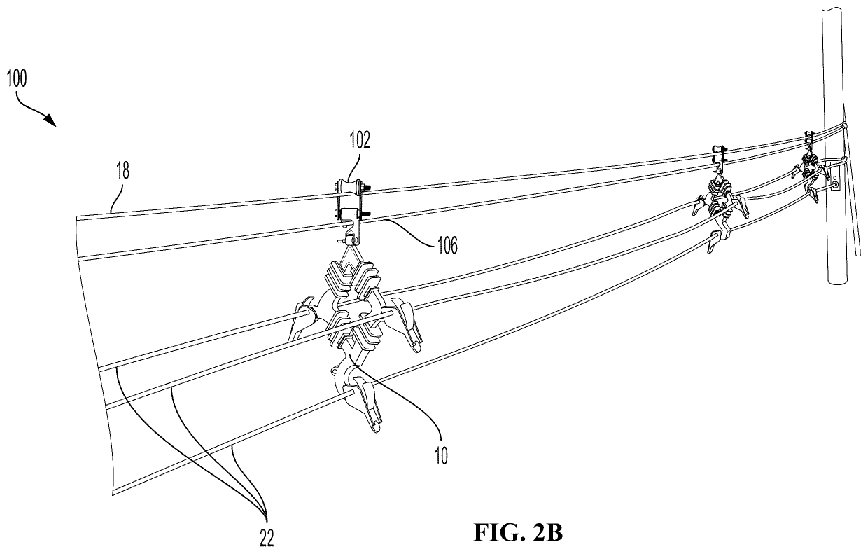

FIG. 2A depicts a perspective view of a dual messenger rolling spacer on a fixed messenger wire, according to one or more aspects described herein;

FIG. 2B depicts a pictorial view of a dual messenger rolling spacer in use on a fixed messenger wire, according to one or more aspects described herein;

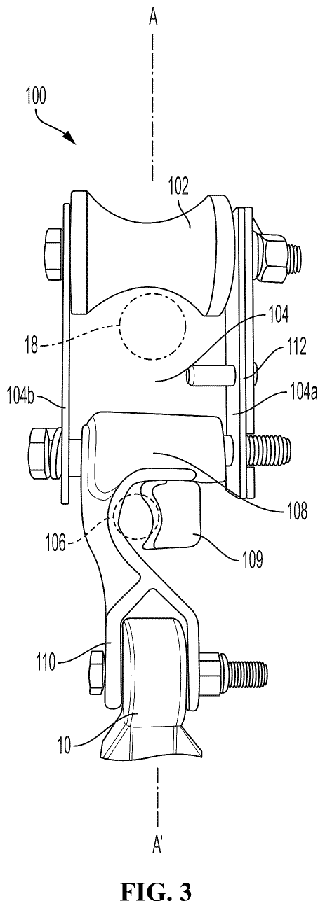

FIG. 3 depicts a perspective view of example embodiment of a dual messenger rolling spacer, according to one or more aspects described herein;

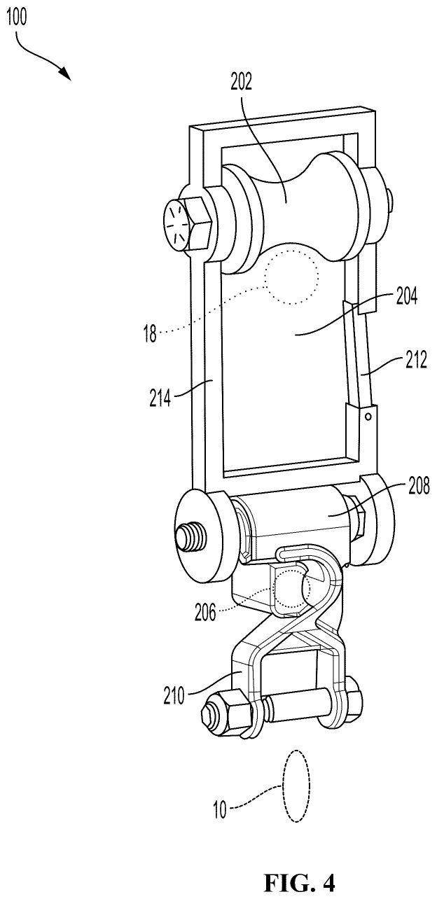

FIG. 4 depicts a perspective view of another example embodiment of a dual messenger rolling spacer, according to one or more aspects described herein;

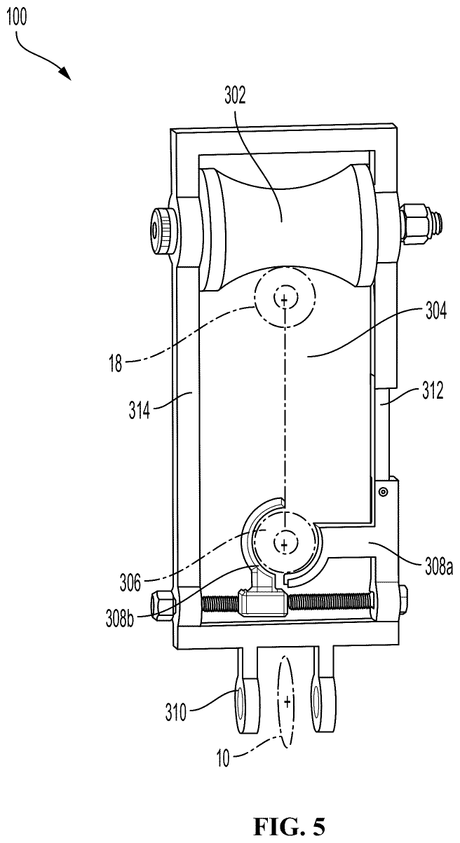

FIG. 5 depicts a perspective view of yet another example embodiment of a dual messenger rolling spacer, according to one or more aspects described herein;

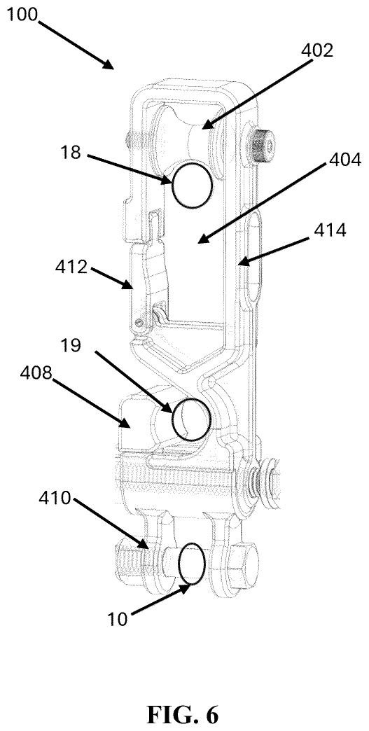

FIG. 6 depicts a perspective view of yet another example embodiment of a dual messenger rolling spacer, according to one or more aspects described herein; and

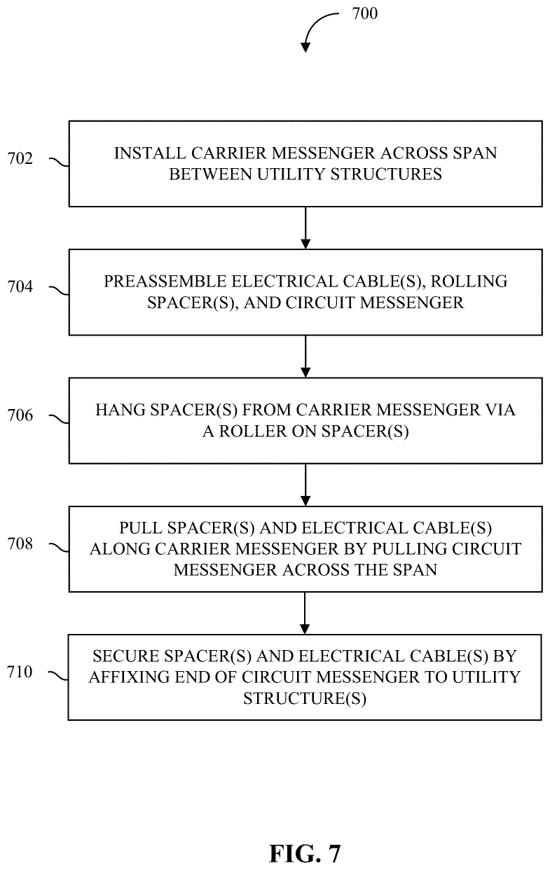

FIG. 7 depicts a flow diagram of an example method for using a dual messenger rolling cable spacer to install cables in an overhead transmission and distribution system, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

The invention described herein relates to an apparatus used to install cables in overhead transmission and distribution systems. The apparatus described herein may comprise a dual messenger rolling cable spacer used to install cables in overhead transmission and distribution systems. As used herein, “dual messenger rolling cable spacer” may be used interchangeably with “rolling cable spacer,” “rolling spacer,” or simply “spacer.” In various embodiments, the rolling cable spacer described herein may be configured to facilitate the installation of cables on fixed messenger wires across inaccessible spans. FIG. 2A depicts a perspective view of a dual messenger rolling spacer 100 on a fixed messenger wire 18, according to one or more aspects described herein. In various embodiments, dual messenger rolling spacer 100 may include a roller 102, a retaining portion 104, a second messenger cable 106, and/or one or more other components. In various embodiments, roller 102 may be attached to a top end of a spacer 10 and configured to be in contact with, and allow non-frictional movement along, fixed messenger wire 18 (also referred to herein as a “carrier messenger”). In various embodiments, retaining portion 104 may comprise a mechanism utilized to secure dual messenger rolling spacer 100 to fixed messenger wire 18. For example, retaining portion 104 may be configured to ensure roller 102 does not fall off either side of fixed messenger wire 18. In some embodiments, retraining frame 104 may be formed by a set of retaining brackets 104a, 104b. In various embodiments, dual messenger rolling cable spacer 100 may be affixed to a second messenger wire 106 (also referred to herein as a “circuit messenger”) that is used by a utility worker to pull electrical circuit cables and a set of preassembled dual messenger rolling spacers 100 (each with a spacer 10) across a span along fixed messenger wire 18.

FIG. 2B depicts a pictorial view of a dual messenger rolling spacer 100 in use on a fixed messenger wire, according to one or more aspects described herein. As shown in FIG. 2B, dual messenger rolling spacer 100 may include a spacer component 10 configured to retain a plurality of cables 22 and suspend them in a position below fixed messenger wire 18. In various embodiments, roller 102 may engage with the existing messenger cable 18 (a first messenger cable, or carrier messenger) and enables the existing spacer 10 to roll along the existing messenger cable 18 across a span, i.e., from a starting point (e.g., departure pole) to a destination point (e.g., an arrival pole). In various embodiments, dual messenger rolling spacer 100 may include the second messenger cable 106 that spacer 10 is fixed to and configured to be used to pull spacer 10 (along with the plurality of cables 22 that they secure) across a span. In such embodiments, second messenger cable 106 may be installed along the existing messenger cable 18 and pulled/towed by an operator (e.g., via a pulling rope or using another towing device).

In various embodiments, a set of dual messenger rolling spacers 100 (each with a spacer 10 securing a plurality of cables 22) may be preassembled at a departure pole. In other words, a plurality of cables 22 may be secured to a set of spacers 10 each attached to a dual messenger rolling spacer 100 affixed to a second messenger cable 106 before the assembled components are suspended from the existing (or fixed) messenger wire 18 via the roller 102 of dual messenger rolling spacer 100. In an example implementation, the set of components (e.g., the plurality of cables 22 and the dual messenger rolling spacers 100 each comprising a spacer 10) may be preassembled after every 30 feet of pull movement. In some implementations, this preassembly may occur near the top of the departure pole. After the plurality of cables 22 are installed by pulling the set of dual messenger rolling spacers 100 along the existing messenger wire 18 via second messenger cable 106, the second messenger cable 106 may be fixed to the departure pole (e.g., just below existing messenger wire 18). In various implementations, the second messenger cable 106 may be affixed to the arrival pole, for example, through a turnbuckle just below the existing messenger wire 18. In such implementations, the turnbuckle may then be adjusted so that sag of second messenger cable 106 matches the sag or catenary of existing messenger wire 18.

Dual messenger rolling spacer 100 may allow for reduced cost and improved control during the installation process for overhead transmission and distribution cable by allowing a utility worker to pull a set of preassembled cables and spacers across an existing messenger wire without requiring the installation devices with permanent retention components. Additionally, for inaccessible spans in particular where a bosun chair was conventionally required to attach a utility worker to an overhead messenger wire, dual messenger rolling spacer 100 reduces the risk to the safety of the utility worker by eliminating the need to replace installation devices with spacers at various locations across the otherwise inaccessible span.

As described herein, FIGS. 3-5 depict various non-limiting example embodiments of dual messenger rolling spacer 100, according to one or more aspects described herein. The components of the embodiments of dual messenger rolling spacer 100 depicted in each of FIGS. 3-5 may be variously combined to form a single dual messenger rolling spacer 100 to be attached to a spacer 10 and used on an existing messenger wire 18.

FIG. 3 depicts a perspective view of example embodiment of dual messenger rolling spacer 100, according to one or more aspects described herein. In some embodiments (e.g., as shown in FIG. 3), dual messenger rolling spacer 100 may include a roller 102, retaining brackets 104a, 104b, a second messenger cable 106, a second messenger holder 108, and/or one or more other components, as described herein. In various embodiments, roller 102 may be used during an installation process of utility cables used in the transmission and distribution of electrical power or for communication. In various embodiments, retaining brackets 104a, 104b may be configured to connect roller 102 to second messenger holder 108, where second messenger cable 106 is secured by second messenger holder 108.

In some embodiments, second messenger holder 108 may be configured to rigidly secure the various components of dual messenger rolling spacer 100 to second messenger cable 106. For example, second messenger holder 108 may include a locking portion 109 (such as a jaw or other component configured to rigidly secure the various components of dual messenger rolling spacer 100 to second messenger cable 106) that can be clamped or retracted between a fully clamped position (when the wire is pulled or in use) and a retracted position manually. In other embodiments, second messenger cable 106 may be secured by second messenger holder 108 in a fully clamped position via a biasing component. In various implementations, the biasing component may comprise a spring. For example, the biasing component may comprise a helical compression spring, or any other suitable type of spring. In various embodiments, locking portion 109 may be configured to receive any appropriate biasing or locking components. In some embodiments, the biasing component may be adjusted to maintain a predetermined maximum and/or minimum length within the second messenger holder 108. In some embodiments, the locking portion of second messenger holder 108 may be mated to biasing or locking components using any appropriate configuration. In some embodiments, second messenger holder 108 may include a groove, notch, or other type of compression. In some embodiments, second messenger cable 106 may be secured by second messenger holder 108 in a fully clamped position via a magnet, hook and fasteners, and/or other mechanisms used to secure second messenger holder 108 instead of or in addition to a biasing component described herein.

In some embodiments, dual messenger rolling spacer 100 may include an opening gate portion 112 configured to bring the existing messenger wire 18 and secure within a retaining portion 104 formed by retaining brackets 104a, 104b. For example, opening gate portion 112 may use a bolt through openings or holes located in the retaining brackets 104a, 104b to secure within the retaining portion 104, as shown in FIG. 3. In various embodiments, opening gate portion 112 may include any suitable shape, size, type, or configuration whereby it may engage or disengage at an appropriate configuration between open position and fully closed position.

In various embodiments, dual messenger rolling spacer 100 may include an attachment portion 110 that can be used to removably attach a spacer 10. For example, as shown in FIG. 3, dual messenger rolling spacer 100 may include an attachment portion 110 comprising clevis coupler receiver that may receive a mating clevis pin to removably (but rigidly) attach dual messenger rolling spacer 100 to a spacer 10. In various embodiments, attachment portion 110 may be located proximate or adjacent to a top portion of spacer 10. In various embodiments, the attachment portion 110 may be extending downwardly away from roller 102 along a line A-A′ perpendicular to a ground surface where the installation occurs.

FIG. 4 depicts a perspective view of another example embodiment of a dual messenger rolling spacer 100, according to one or more aspects described herein. In some embodiments (e.g., as shown in FIG. 4), dual messenger rolling spacer 100 may include a roller 202, a retaining portion 204, a second messenger cable 206, a second messenger holder 208, and/or one or more other components, as described herein. In various embodiments, roller 202 may be used during an installation process of utility cables used in the transmission and distribution of electrical power or for communication. In various embodiments, dual messenger rolling spacer 100 may include a retaining frame 214 configured to define a retaining portion 204 and connect roller 202 to second messenger holder 208, where second messenger cable 206 is secured by second messenger holder 208. In some embodiments, retaining frame 214 may include a ratchet portion 212 for removably securing existing messenger wire 18 within retaining portion 204 defined (and surrounded) by retaining frame 214. In various embodiments, ratchet portion 212 may include any suitable shape, size, type, or configuration whereby it may pivot at an appropriate angle between open position and fully closed position. In various embodiments, dual messenger rolling spacer 100 may include an attachment portion 210 that can be used to removably attach a spacer 10.

FIG. 5 depicts a perspective view of yet another example embodiment of dual messenger rolling spacer 100, according to one or more aspects described herein. In some embodiments (e.g., as shown in FIG. 5), dual messenger rolling spacer 100 may include a roller 302, a retaining portion 304, a second messenger cable 306, a second messenger holder formed by a first locking arm 308a and a second locking arm 308b, and/or one or more other components, as described herein. In various embodiments, roller 302 may be used during an installation process of utility cables used in the transmission and distribution of electrical power or for communication. In various embodiments, dual messenger rolling spacer 100 may include a retaining frame 314 configured to define a retaining portion 304 and connect roller 302 to second messenger holder, where second messenger cable 306 is secured by second messenger holder. In some embodiments, retaining frame 314 may include a ratchet portion 312 for removably securing existing messenger wire 18 within retaining portion 304 defined (and surrounded) by retaining frame 314. In various embodiments, ratchet portion 312 may include any suitable shape, size, type, or configuration whereby it may pivot at an appropriate angle between open position and fully closed position. In various embodiments, dual messenger rolling spacer 100 may include an attachment portion 310 that can be used to removably attach a spacer 10.

As depicted in FIG. 5, in some embodiments, second messenger holder may comprise a first locking arm 308a and a second locking arm 308b configured to engage with first locking arm 308a to clamp around second messenger cable 306. In such embodiments, a locking mechanism may be operatively coupled with first locking arm 308a and second locking arm 308b, wherein the locking mechanism positions first locking arm 308a relative to second locking arm 308b. In some embodiments, first locking arm 308a and second locking arm 308b may be adjustable relative to one another between a retracted position and an extended portion. In some embodiments, first locking arm 308a and second locking arm 308b may use a ratchet type locking mechanism to secure second messenger cable 306 in a fully clamped position. In various embodiments, the second messenger holder may be of any appropriate shape, size, type, or configuration whereby it may extend at an appropriate length between retracted position and fully clamped position. In various embodiments, the second messenger holder may include any suitable number of locking arms (e.g., first locking arm 308a, second locking arm 308b, and/or one or more additional locking arms). In various embodiments, the second messenger holder may include a first locking arm and two or more locking arms that may be engaged with the first locking arm.

FIG. 6 depicts a perspective view of another example embodiment of a dual messenger rolling spacer 100, according to one or more aspects described herein. In some embodiments (e.g., as shown in FIG. 6), dual messenger rolling spacer 100 may include a roller 402, a retaining portion 404, a primary messenger 18, a second messenger cable 19, a second messenger holder 408, and/or one or more other components, as described herein. In various embodiments, roller 402 may be used during an installation process of utility cables used in the transmission and distribution of electrical power or for communication. In various embodiments, dual messenger rolling spacer 100 may include a retaining frame 414 configured to define a retaining portion 404 and connect roller 402 to primary, where second messenger cable 19 is secured by second messenger holder 408. In some embodiments, dual messenger rolling spacer 100 may be configured to use gravity to keep second messenger cable 19 in place while the second messenger holder 408 and other components of dual messenger rolling spacer 100 are tightened. In various embodiments, and as depicted in FIG. 6, second messenger cable 19 is located outside of retaining portion 404. In some embodiments, retaining frame 414 may include a ratchet portion 412 for removably securing existing messenger wire 18 within retaining portion 404 defined (and surrounded) by retaining frame 414. As used herein, ratchet portion 412 (and similar elements associated with like reference numerals) may be interchangeably referred to as latch 412 or gate 412. In various embodiments, ratchet portion 412 may include any suitable shape, size, type, or configuration whereby it may pivot at an appropriate angle between open position and fully closed position. In various embodiments, dual messenger rolling spacer 100 may include an attachment portion 410 that can be used to removably attach a spacer 10.

FIG. 7 depicts a flow diagram of an example process 700 for using a dual messenger rolling cable spacer to install cables in an overhead transmission and distribution system, according to one or more aspects described herein. The operations of process 700 presented below are intended to be illustrative and, as such, should not be viewed as limiting. In some implementations, process 700 may be accomplished with one or more additional operations not described, and/or without one or more of the operations discussed. In some implementations, two or more of the operations of process 700 may occur substantially simultaneously. The described operations may be accomplished using some or all of the system components described in detail above.

In an operation 702, process 700 may include installing a carrier messenger wire across a span between utility structures. For example, utility structures may comprise poles and/or other structures used to suspend wires and cables in overhead transmission and distribution systems. In various embodiments, the carrier messenger wire may be rigidly affixed to a utility structure on each end of the span. In an operation 704, process 700 may include preassembling a set of one or more cables, one or more rolling spacers used to retain the set of cables, and a circuit messenger wire. In various embodiments, the circuit messenger wire comprises a second separate messenger wire that is provided in addition to the carrier messenger wire. In various embodiments, the set of cables, the one or more rolling spacers, and the circuit messenger wire may be preassembled by clamping each of the set of cables and the circuit messenger wire to the one or more rolling spacers. In some embodiments, the set of cables, the one or more rolling spacers, and the circuit messenger wire may be preassembled at a first utility structure of a set of utility structures across which the carrier messenger wire is installed (i.e., in operation 702).

In an operation 706, process 700 may include hanging the one or more rolling spacers (to which the set of cables and the circuit messenger wire are affixed) from the carrier messenger wire. In various embodiments, each of the one or more rolling spacers are hung from the carrier messenger wire from a roller of the one or more rolling spacers such that the roller is in contact with the carrier messenger wire. Thus, in various embodiments, the one or more rolling spacers are configured to roll along the carrier messenger wire when hung from the carrier messenger wire. In an operation 708, process 700 may include pulling the circuit messenger wire across the span. For example, in various embodiments, the circuit messenger wire is pulled across the span from the first utility structure to a second utility structure of the set of utility structures across which the carrier messenger wire is installed (i.e., in operation 702). Because the circuit messenger wire is clamped to each of the one or more rolling spacers, and each of the one or more rolling spacers are clamped to the set of cables, pulling the circuit messenger wire across the span causes the one or more rolling spacers to roll along the carrier messenger wire, thereby pulling the set of cables across the span. In an operation 710, process 700 may include securing the set of cables and the one or more rolling spacers in place by affixing the circuit messenger wire to the utility structure defining an end of the span. For example, in various embodiments, the set of cables and the one or more rolling spacers are secured in place by affixing the end of the circuit messenger wire pulled across the span to a second utility structure of the set of utility structures across which the carrier messenger wire is installed (i.e., in operation 702). In various embodiments, the set of cables and the one or more rolling spacers are secured in place by affixing the circuit messenger wire to each utility structure of the set of utility structures across which the carrier messenger wire is installed (i.e., in operation 702)

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one embodiment”, “an embodiment”, “some embodiments”, “various embodiments”, “certain embodiments”, “other embodiments”, “one series of embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method of using dual messenger rolling cable spacers to install cables in an overhead transmission and distribution system, the method comprising:
installing a carrier messenger wire across a span between utility structures;
preassembling a set of one or more cables, one or more rolling spacers used to retain the set of cables, and a circuit messenger wire;
hanging the one or more rolling spacers from the carrier messenger wire, wherein the set of cables and the circuit messenger wire are affixed to the one or more rolling spacers;
pulling the circuit messenger wire across the span causing the one or more rolling spacers to roll along the carrier messenger wire, thereby pulling the set of cables across the span; and
securing the set of cables and the one or more rolling spacers in place by affixing the circuit messenger wire to a utility structure defining an end of the span.

2. The method of claim 1, wherein the utility structures comprise poles or other structures used to suspend wires and cables in overhead transmission and distribution systems.

3. The method of claim 1, wherein the carrier messenger wire is rigidly affixed to a utility structure on each end of the span.

4. The method of claim 1, wherein the circuit messenger wire comprises a second separate messenger wire that is provided in addition to the carrier messenger wire.

5. The method of claim 1, wherein preassembling the set of cables, the one or more rolling spacers, and the circuit messenger wire comprises clamping each of the set of cables and the circuit messenger wire to the one or more rolling spacers.

6. The method of claim 1, wherein each of the one or more rolling spacers are hung from the carrier messenger wire via a roller of the one or more rolling spacers such that the roller is in contact with the carrier messenger wire.

7. The method of claim 6, wherein the one or more rolling spacers are configured to roll along the carrier messenger wire when hung from the carrier messenger wire.
